(19) United States
(12) Patent Application Publication
(10) Pub. No.: US 2012/0249500 A1
(43) Pub. Date: Oct. 4, 2012

(54) METHOD OF DRIVING PLASMA DISPLAY DEVICE, PLASMA DISPLAY DEVICE, AND PLASMA DISPLAY SYSTEM

(76) Inventors: Takahiko Origuchi, Osaka (JP); Yuya Shiozaki, Osaka (JP); Shigeo Kigo, Osaka (JP); Yutaka Yoshihama, Osaka (JP); Mitsuhiro Ishizuka, Osaka (JP)

(21) Appl. No.: 13/515,765

(22) PCT Filed: Dec. 14, 2010
(86) PCT No.: PCT/JP2010/007249

§ 371 Date: Jun. 13, 2012

(30) Foreign Application Priority Data
Dec. 14, 2009 (JP) 2009-282500

(51) Int. Cl. G09G 3/28; G06F 3/038

(52) U.S. Cl. 345/204; 345/60

(57) ABSTRACT

An address period is shortened while degradation of image display quality of a plasma display apparatus is suppressed. For this purpose, in a driving method for a plasma display apparatus including a plasma display panel with a plurality of discharge cells having a scan electrode, a sustain electrode, and a data electrode, and a driver circuit, the following operation is performed. The driver circuit forms one field period by a subfield that displays an interlace signal as an image signal thinned out every one line and a subfield that displays oblique line interpolated data generated by interpolating oblique lines detected by an image signal. In the subfield displaying an image signal, the driver circuit performs two-line simultaneous address operation with application of a scan pulse simultaneously to two adjacent scan electrodes so as to generate an address discharge in a discharge cell.

### TECHNICAL FIELD

The present invention relates to a plasma display apparatus driving method, a plasma display apparatus, and a plasma display system that enable the user to stereoscopically view a stereoscopic image that is made of an image for the right eye and an image for the left eye alternately displayed on a plasma display panel, using a pair of shutter glasses.

### BACKGROUND ART

An AC surface discharge panel, i.e. a typical plasma display panel (hereinafter, simply referred to as “panel”), has a front substrate and a rear substrate opposed to each other. A plurality of display electrode pairs, each including a scan electrode and a sustain electrode, is formed on the front substrate. A plurality of data electrodes is formed on the rear substrate. A large number of discharge cells are formed between the substrates. Ultraviolet rays are generated by gas discharge in the discharge cells. The ultraviolet rays excite phosphors in the red color, green color, and blue color so that light is emitted for the display of a color image.

A typically used driving method for the panel is a subfield method. In the subfield method, gradations are displayed by dividing one field period into a plurality of subfields and causing light emission or no light emission in each discharge cell in each subfield. Each of the subfields has an initializing period, an address period, and a sustain period.

In the initializing period, an initializing operation is performed so as to cause an initializing discharge in the discharge cells and to form wall charge necessary for the subsequent address operation. In the address period, an address operation is performed so as to cause an address discharge selectively in the discharge cells in response to an image to be displayed and to form wall charge in the discharge cells. In the sustain period, a sustain operation is performed so as to apply sustain pulses in number predetermined for each subfield alternately to the scan electrodes and the sustain electrodes and to generate sustain discharge in the discharge cells. The sustain operation causes the phosphor layers to emit light in the discharge cells having undergone the address discharge, and lights the discharge cells at luminances corresponding to the gradation values of image signals. Thus, an image is displayed in the image display area of the panel.

The above subfield method has the following problem. When increases in the size and definition of the panel increase the number of scan electrodes, the time taken in the address period increases and thus the time usable for the sustain operation decreases.

In order to address this problem, a driving method for performing a “simultaneous address operation” is proposed. The simultaneous address operation is a driving method for performing an address operation by applying a scan pulse to a plurality of scan electrodes simultaneously (see Patent Literature 1, for example). The simultaneous address operation can shorten the time taken for the address operation and thus the address period, and thereby increase the number of subfields and increase the time taken for the sustain operation, for example.

Application of a plasma display apparatus as a three-dimensional (hereinafter, “3D”) image display apparatus is considered.

In this plasma display apparatus, an image for the right eye and an image for the left eye that form a stereoscopic-view (3D) image are alternately displayed on a panel. The user views the image using a pair of special glasses, called shutter glasses.

A pair of shutter glasses includes a shutter for the right eye and a shutter for the left eye. In the period during which an image for the right eye is displayed on the panel, the right eye shutter is opened (in a state of transmitting visible light) and the left eye shutter is closed (in a state of blocking the visible light). In the period during which an image for the left eye is displayed, the left eye shutter is opened and the right eye shutter is closed. With this operation, the user can view the image for the right eye only with the right eye, and the image for the left eye only with the left eye. Thus, the user can stereoscopically view the display image.

In this manner, in order to display one 3D image in a plasma display apparatus used as a 3D image display apparatus, it is necessary to display two images, i.e. one image for the right eye and one image for the left eye. Thus, the user who views a 3D image through a pair of shutter glasses perceives the number of images displayed on the panel per second as a half the number of fields per second.

For instance, suppose the field frequency (the number of fields occurring per second) of images displayed on the panel is 60 Hz. In this case, when the images are ordinary images (2D images) instead of 3D images, sixty 2D images are displayed per second. When the images are 3D images, thirty 3D images are displayed per second.

Therefore, in order to display sixty 3D images per second, it is necessary to set the field frequency to 120 Hz, which is twice as high as 60 Hz. In this case, the time usable to display one image for the right eye or one image for the left eye is limited to a half the time usable to display one 2D image.

In such a case, as a method for reducing the time taken to drive the panel, the above driving method using the simultaneous address operation is effective. However, in the driving method using the simultaneous address operation, the resolution (hereinafter, “vertical resolution”) in the direction orthogonal to the scan electrodes (hereinafter, “vertical direction”) tends to degrade. For instance, in the case where a scan pulse is simultaneously applied to two adjacent scan electrodes, an address operation is performed on the two scan electrodes simultaneously. Thus, in an image displayed on the panel, the respective discharge cells formed on the adjacent two scan electrodes emit light in the same pattern. For this reason, in the direction orthogonal to the scan electrodes (vertical direction), the resolution of the image decreases to the resolution caused by a half the number of scan electrodes.

The following impairment is confirmed in an image with a low vertical resolution. When an image including a pattern of oblique lines is displayed with a low vertical resolution, the smoothness of the oblique lines are more likely to be impaired than that in the image with a high vertical resolution. Especially in a moving image where oblique lines move at a specific speed, degradation of oblique lines is conspicuous.

When a 3D image is displayed by driving a panel by a driving method using simultaneous address operation in a plasma display apparatus used as a 3D image display apparatus, in order to ensure the image display quality, it is important to smoothly display oblique lines moving at a specific speed in a moving image and to suppress the degradation of the image display quality.

### CITATION LIST

### Patent Literature

PTL1

Japanese Patent Unexamined Publication No. 2008-116894

### SUMMARY OF THE INVENTION

In a plasma display apparatus driving method,
the plasma display apparatus including:
   a panel having a plurality of discharge cells arranged therein, each of the discharge cells having a scan electrode, a sustain electrode, and a data electrode; and
   a driver circuit for driving the panel, the driving method includes:
forming one field period formed of a subfield that displays an interlace signal as an image signal “thinned out” every one line and a subfield that displays oblique line interpolated data generated by interpolating oblique lines detected by an image signal,
in the subfield displaying an image signal, performing two-line simultaneous address operation for applying a scan pulse simultaneously to two adjacent scan electrodes.

This method shortens the address period while suppressing degradation of the image display quality when a 3D image is displayed in the plasma display apparatus usable as a 3D image display apparatus. Thus, a smooth moving 3D image can be displayed on the panel.

A plasma display apparatus includes the following elements:
a panel having a plurality of discharge cells arranged therein, each of the discharge cells having a scan electrode, a sustain electrode, and a data electrode; and
a driver circuit for driving the panel.

The driver circuit forms one field period of a subfield that displays an interlace signal as an image signal thinned out every one line and a subfield that displays oblique line interpolated data generated by interpolating oblique lines detected by an image signal. In the subfield displaying an image signal, the driver circuit performs two-line simultaneous address operation with application of a scan pulse simultaneously to two adjacent scan electrodes so as to generate an address discharge in a discharge cell.

This configuration shortens the address period while suppressing degradation of the image display quality when a 3D image is displayed in the plasma display apparatus usable as a 3D image display apparatus. Thus, a smooth moving 3D image can be displayed on the panel.

A plasma display system includes the following elements:
a panel having a plurality of discharge cells arranged therein, each of the discharge cells having a scan electrode, a sustain electrode, and a data electrode;
a driver circuit; and
a pair of shutter glasses.

The driver circuit receives a stereoscopic-view image signal in which an image signal for the right eye and an image signal for the left eye, each of image signals is an interlace signal thinned out every one line, are alternately repeated by field.

The driver circuit forms one field period of a subfield that displays an image signal and a subfield that displays oblique line interpolated data generated by interpolating oblique lines detected by an image signal. In the subfield displaying an image signal, the driver circuit performs two-line simultaneous address operation with simultaneous application of scan pulses to two adjacent scan electrodes so as to generate an address discharge in a discharge cell. The driver circuit includes a timing signal output part for outputting a timing signal in synchronization with the field for the right eye and the field for the left eye. The pair of shutter glasses opens and closes a right eye shutter and a left eye shutter based on a timing signal output from the timing signal output part.

This configuration shortens the address period while suppressing degradation of the image display quality when a 3D image is displayed in the plasma display system including the plasma display apparatus usable as a 3D image display apparatus. Thus, a smooth moving 3D image can be displayed on the panel.

### BRIEF DESCRIPTION OF DRAWINGS

FIG. 1 is an exploded perspective view showing a structure of a panel for use in a plasma display apparatus in accordance with a first exemplary embodiment of the present invention.

FIG. 2 is an electrode array diagram of the panel for use in the plasma display apparatus in accordance with the first exemplary embodiment.

FIG. 3 shows a circuit block diagram of the plasma display apparatus and a diagram outlining a plasma display system in accordance with the first exemplary embodiment.

FIG. 4 is a chart of driving voltage waveforms applied to respective electrodes of the panel used for the plasma display apparatus in accordance with the first exemplary embodiment.

FIG. 5 is a schematic diagram showing a subfield structure of the plasma display apparatus and an opening/closing operation of a pair of shutter glasses in accordance with the first exemplary embodiment.

FIG. 6 is a circuit block diagram showing the image signal processing circuit of the plasma display apparatus in accordance with the first exemplary embodiment.

FIG. 7 is a circuit block diagram showing the oblique line detecting part of the plasma display apparatus in accordance with the first exemplary embodiment.

FIG. 8 is a circuit block diagram showing the interpolated data generating part of the plasma display apparatus in accordance with the first exemplary embodiment.

FIG. 9A illustrates the workings of the oblique line interpolation circuit of the plasma display apparatus in accordance with the first exemplary embodiment.

FIG. 9B illustrates the workings of the oblique line interpolation circuit of the plasma display apparatus in accordance with the first exemplary embodiment.

FIG. 9C illustrates the workings of the oblique line interpolation circuit of the plasma display apparatus in accordance with the first exemplary embodiment.

FIG. 9D illustrates the workings of the oblique line interpolation circuit of the plasma display apparatus in accordance with the first exemplary embodiment.

FIG. 9E illustrates the workings of the oblique line interpolation circuit of the plasma display apparatus in accordance with the first exemplary embodiment.

FIG. 9F illustrates the workings of the oblique line interpolation circuit of the plasma display apparatus in accordance with the first exemplary embodiment.

FIG. 9G illustrates the workings of the oblique line interpolation circuit of the plasma display apparatus in accordance with the first exemplary embodiment.

FIG. 9H illustrates the workings of the oblique line interpolation circuit of the plasma display apparatus in accordance with the first exemplary embodiment.

FIG. 9I illustrates the workings of the oblique line interpolation circuit of the plasma display apparatus in accordance with the first exemplary embodiment.

FIG. 9J illustrates the workings of the oblique line interpolation circuit of the plasma display apparatus in accordance with the first exemplary embodiment.

FIG. 10A illustrates oblique line interpolated data of the plasma display apparatus in accordance with a second exemplary embodiment.

FIG. 10B illustrates oblique line interpolated data of the plasma display apparatus in accordance with the second exemplary embodiment.

FIG. 10C illustrates oblique line interpolated data of the plasma display apparatus in accordance with the second exemplary embodiment.

FIG. 11 is a chart of driving voltage waveforms applied to respective electrodes of the panel used for the plasma display apparatus in accordance with the second exemplary embodiment.

### DESCRIPTION OF EMBODIMENTS

Hereinafter, a plasma display apparatus in accordance with an exemplary embodiment of the present invention is described, with reference to the accompanying drawings.

### First Exemplary Embodiment

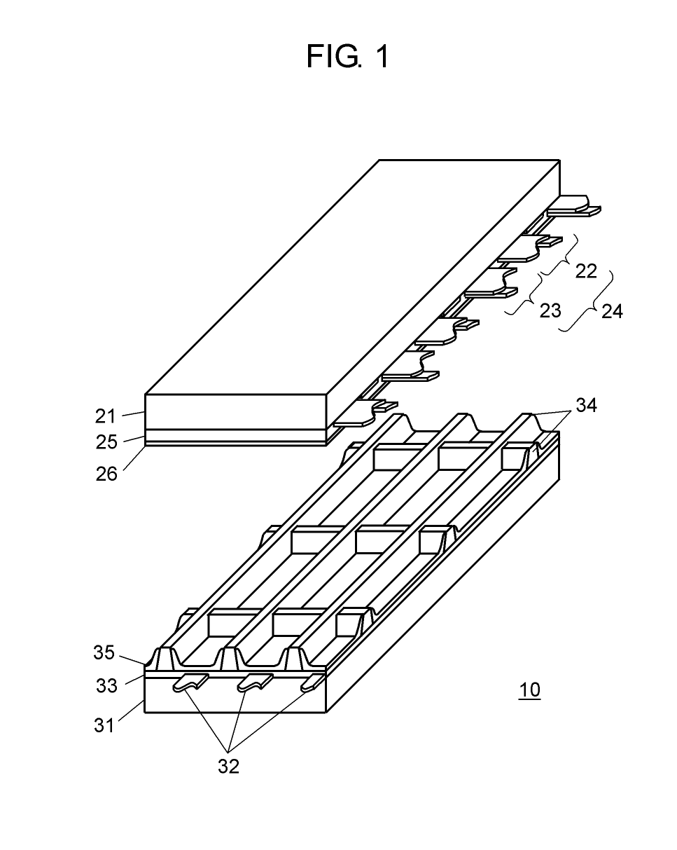

FIG. 1 is an exploded perspective view showing a structure of panel 10 for use in the plasma display apparatus in accordance with the exemplary embodiment of the present invention. A plurality of display electrode pairs 24, each including scan electrode 22 and sustain electrode 23, is disposed on glass front substrate 21. Dielectric layer 25 is formed so as to cover scan electrodes 22 and sustain electrodes 23. Protective layer 26 is formed over dielectric layer 25. Protective layer 26 is made of a material predominantly composed of magnesium oxide (MgO).

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red color (R), green color (G), and blue color (B) are formed.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a mixture gas of neon and xenon, for example, is sealed as a discharge gas. In this embodiment, a discharge gas having a xenon partial pressure of approximately 10% is used to enhance emission efficiency.

The discharge space is partitioned into a plurality of compartments by barrier ribs 34. Discharge cells are formed in the intersecting parts of display electrode pairs 24 and data electrodes 32. The discharge cells discharge and emit light (light up) so as to display a color image on panel 10.

In panel 10, three successive discharge cells arranged in the extending direction of display electrode pair 24, i.e. a discharge cell for emitting light of red color (R), a discharge cell for emitting light of green color (G), and a discharge cell for emitting light of blue (B) color, form one pixel.

The structure of panel 10 is not limited to the above, and may include barrier ribs in a stripe pattern, for example. The mixture ratio of the discharge gas is not limited to the above numerical value, and other mixture ratios may be used.

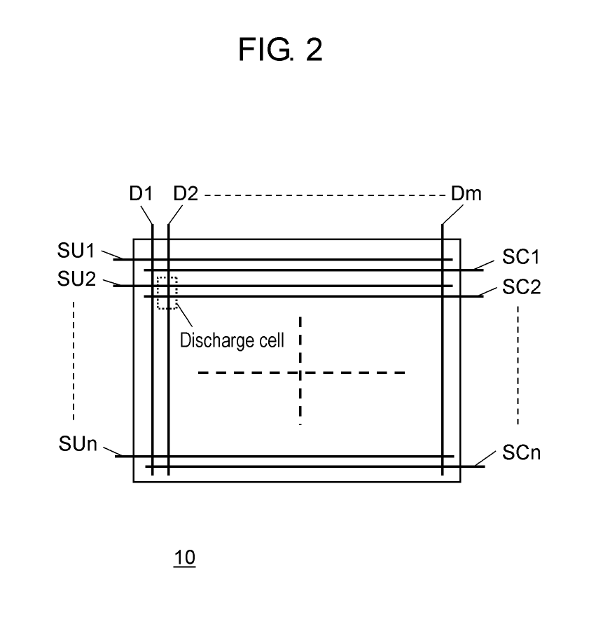

FIG. 2 is an electrode array diagram of panel 10 for use in the plasma display apparatus in accordance with the exemplary embodiment of the present invention. Panel 10 has n scan electrodes (SC1 through SCn that form scan electrodes 22 in FIG. 1) and n sustain electrodes (SU1 through SUn that form sustain electrodes 23 in FIG. 1) both long in the row direction (line direction), and m data electrodes (D1 through Dm that form data electrodes 32 in FIG. 1) long in the column direction. A discharge cell is formed in the part where a pair of scan electrode SCi (i=1 to n) and sustain electrode SUi intersects one data electrode Dj (j=1 to m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920p33 3 and n=1080.

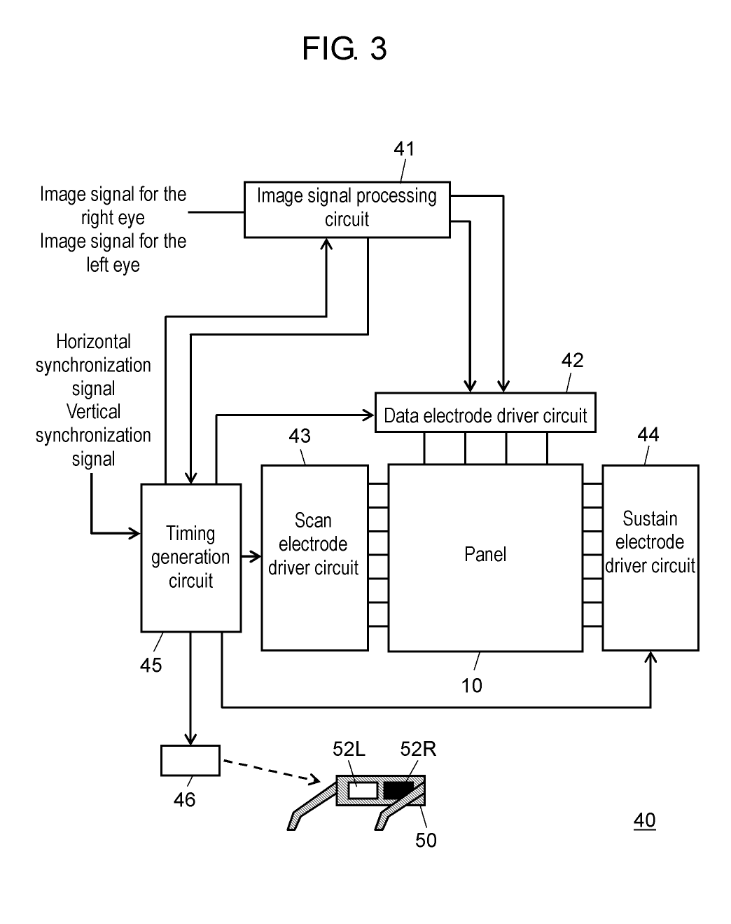

FIG. 3 shows a circuit block diagram of plasma display apparatus 40 and a diagram outlining a plasma display system in accordance with the exemplary embodiment of the present invention. The plasma display system of this exemplary embodiment includes plasma display apparatus 40 and pair of shutter glasses 50 as the elements.

Plasma display apparatus 40 also includes the following elements:
panel 10 having a plurality of discharge cells arranged therein, each of the discharge cells having scan electrode 22, sustain electrode 23, and data electrode 32; and
a driver circuit for driving panel 10.
   The driver circuit includes image signal processing circuit 41; data electrode driver circuit 42; scan electrode driver circuit 43; sustain electrode driver circuit 44; timing generation circuit 45; and electric power supply circuits (not shown) for supplying electric power necessary for each circuit block. Plasma display apparatus 40 includes timing signal output part 46. Timing signal output part 46 outputs a timing signal for opening/closing shutters that controls the opening/closing of the shutters of pair of shutter glasses 50 used by the user.

Image signal processing circuit 41 allocates gradation values to each discharge cell, based on an input image signal. The image signal processing circuit converts the gradation values into image data representing light emission and no light emission in each subfield. For instance, when input image signal sig includes an R signal, a G signal, and a B signal, R, G, and B gradation values are allocated to the respective discharge cells, based on the R signal, G signal, and B signal. When input image signal sig includes a luminance signal (Y signal) and a chroma signal (C signal, R-Y signal and B-Y signal, u signal and v signal, or the like), the R signal, the G signal, and the B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield. When the input image signal is a 3D image signal including an image signal for the right eye and an image signal for the left eye and the 3D image signal is displayed on panel 10, the image signal for the right eye and the image signal for the left eye are alternately input to image signal processing circuit 41 in each field. Thus, image signal processing circuit 41 converts the image signal for the right eye into image data for the right eye, and the image signal for the left eye into image data for the left eye.

Besides, image signal processing circuit 41 detects an oblique line from the image signal for the right eye and the image signal for the left eye so as to generate oblique line interpolated data for the right eye and oblique line interpolated data for the left eye. This will be detailed later.

Data electrode driver circuit 42 converts the image data for the right eye, the image data for the left eye, the oblique line interpolated data for the right eye, and the oblique line interpolated data for the left eye into signals (address pulses) corresponding to each of data electrodes D1 through Dm, and applies the signals to each of data electrodes D1 through Dm.

Timing generation circuit 45 generates various timing signals for controlling the operation of each circuit block, based on a horizontal synchronization signal and a vertical synchronization signal, and supplies the generated timing signals to respective circuit blocks (e.g. image signal processing circuit 41, data electrode driver circuit 42, scan electrode driver circuit 43, and sustain electrode driver circuit 44). Timing generation circuit 45 also outputs a timing signal for opening/closing shutters that controls the opening/closing operation of the shutters of pair of shutter glasses 50 to timing signal output part 46. Timing generation circuit 45 sets the timing signal for opening/closing shutters to ON (“1”) when a shutter of pair of shutter glasses 50 opens (in a state of transmitting visible light). The timing generation circuit sets the timing signal for opening/closing shutters to OFF (“0”) when the shutter of pair of shutter glasses 50 closes (in a state of blocking visible light). The timing signals for opening/closing shutters include two types of timing signals: a timing signal (for opening/closing the right eye shutter) that is set to ON in response to a field for the right eye for the display of an image signal for the right eye, and is set to OFF in response to a field for the left eye for the display of an image signal for the left eye; and a timing signal (for opening/closing the left eye shutter) that is set to ON in response to a field for the left eye for the display of an image signal for the left eye, and is set to OFF in response to a field for the right eye for the display of an image signal for the right eye.

Timing signal output part 46 includes a light-emitting element, such as a light-emitting diode (LED), and supplies timing signals for opening/closing shutters to pair of shutter glasses 50 by converting the signals into infrared signals, for example.

Scan electrode driver circuit 43 has an initializing waveform generation circuit, a sustain pulse generation circuit, and a scan pulse generation circuit (not shown). The initializing waveform generation circuit generates an initializing waveform to be applied to scan electrodes SC1 through SCn in the initializing periods. The sustain pulse generation circuit generates a sustain pulse to be applied to scan electrodes SC1 through SCn in the sustain periods. The scan pulse generation circuit has a plurality of scan electrode driver ICs (scan ICs), and generates a scan pulse to be applied to scan electrodes SC1 through SCn in the address periods. Scan electrode driver circuit 43 drives each of scan electrodes SC1 through SCn in response to the timing signals supplied from timing generation circuit 45.

Sustain electrode driver circuit 44 has a sustain pulse generation circuit, and a circuit for generating voltage Ve1 and voltage Ve2 (not shown), and drives sustain electrodes SU1 through SUn in response to the timing signals supplied from timing generation circuit 45.

Pair of shutter glasses 50 has right eye shutter 52R and left eye shutter 52L. Right eye shutter 52R and left eye shutter 52L can be opened and closed independently. Pair of shutter glasses 50 opens and closes right eye shutter 52R and left eye shutter 52L in response to a timing signal for opening/closing shutters that is supplied from timing signal output part 46. Right eye shutter 52R opens (transmits visible light) when the timing signal for opening/closing the right eye shutter is set to ON, and closes (blocks visible light) when the timing signal is set to OFF. Left eye shutter 52L opens (transmits visible light) when the timing signal for opening/closing the left eye shutter is set to ON, and closes (blocks visible light) when the timing signal is set to OFF. Right eye shutter 52R and left eye shutter 52L can be formed of liquid crystal, for example. However, in the present invention, the material forming the shutters is not limited to liquid crystal. As long as blocking and transmission of visible light can be switched at a high speed, any material may be used.

Next, driving voltage waveforms for driving panel 10 and the operation thereof are outlined. Plasma display apparatus 40 of this embodiment display gradations by a subfield method. In the subfield method, one field is divided into a plurality of subfields along a temporal axis, and a luminance weight is set for each subfield. Then, by controlling the light emission and no light emission in each discharge cell in each subfield, an image is displayed on panel 10.

In this exemplary embodiment, image signals input to plasma display apparatus 40 are 3D image signals as interlace signals thinned out every other line. The 3D image signals are stereoscopic-view image signals in which an image signal for the right eye and an image signal for the left eye are alternately repeated by field. Specifically, the image signals are the interlace signals (interlace scan signals) transmitted in the following order: an odd-line image signal for the right eye, an odd-line image signal for the left eye, an even-line image signal for the right eye, and an even-line image signal for the left eye.

Then, a field for the right eye for the display of an image signal for the right eye and a field for the left eye for the display of an image signal for the left eye are alternately repeated. Thereby, a stereoscopic-view image signal made of the image for the right eye and the image for the left eye is displayed on panel 10. Further, the user perceives the stereoscopic-view (3D) image signal displayed on panel 10 through pair of shatter glasses 50 where right eye shutter 52R and left eye shutter 52L are opened and closed in synchronization with the field for the right eye and the field for the left eye. With this operation, the user can stereoscopically view the 3D image displayed on panel 10.

In the field for the right eye and the field for the left eye, only the signals of the images to be displayed are different. The subfield structure, e.g. the number of subfields forming one field, the luminance weights of the subfields, and the arrangement of the subfields, is identical. First, the structure of one field and the driving voltage waveforms applied to the respective electrodes are described. Hereinafter, when a field “for the right eye” and a field “for the left eye” need not be discriminated, each of the field for the right eye and the field for the left eye is simply referred to as a “field”, and each of an image signal for the right eye and an image signal for the left eye is also simply referred to as an “image signal”. Similarly, each of oblique line interpolated data for the right eye and oblique line interpolated data for the left eye is simply referred to as “oblique line interpolated data”.

In this exemplary embodiment, in order for the user to view a smooth 3D moving image, the field frequency (the number of fields occurring per second) is set to a frequency (e.g. 120 Hz) twice as high as an ordinary one. This will be detailed later.

Each field has a plurality of subfields, and each of the subfields has an initializing period, an address period and a sustain period.

In the initializing period, an initializing discharge is caused so as to form wall charge necessary for the subsequent address discharge on the respective electrodes. The initializing operation at this time includes a forced initializing operation and a selective initializing operation. The forced initializing operation forcedly causes initializing discharge in all the discharge cells irrespective of whether a discharge has occurred. The selective initializing operation causes an initializing operation selectively in the discharge cells having undergone an address discharge in the address period of the immediately preceding subfield. Hereinafter, the initializing period where a forced initializing operation is performed is referred to as a forced initializing period. The subfield having a forced initializing period is referred to as “forced initializing subfield”. The initializing period where a selective initializing operation is performed is referred to as a selective initializing period. The subfield having a selective initializing period is referred to as “selective initializing subfield”.

In the address period, an address pulse is selectively applied to data electrodes 32, and an address discharge is caused so as to form wall charge in the discharge cells to be lit. In this exemplary embodiment, two-line simultaneous address operation is performed in the address periods. The two-line simultaneous address operation is an address operation that causes an address discharge in each discharge cell by applying a scan pulse to two adjacent scan electrodes 22 simultaneously; at the same time, applying an address pulse selectively to data electrode 32. This will be described in detail later. Compared to the address operation line by line, the two-line simultaneous address operation shortens the time required for the address period.

In the sustain period, sustain pulses corresponding in number to the luminance weights predetermined for the respective subfields are alternatively applied to display electrode pairs 24. Thereby, sustain discharge is caused in the discharge cells having undergone an address discharge so as to light the discharge cells.

In this exemplary embodiment, each of the field for the right eye and the field for the left eye is formed of six subfields (subfield SF1, subfield SF2, subfield SF3, subfield SF4, subfield SF5, and subfield SF6). Respective subfields have luminance weights of 16, 8, 4, 2, 1, and 8.

The luminance weight represents a ratio of the magnitudes of luminance displayed in the respective subfields. In the sustain period of each subfield, sustain pulses corresponding in number to the luminance weight are generated. For example, in the sustain period of a subfield having the luminance weight “8”, the number of sustain pulses that is four times the number of sustain pulses in the subfield having the luminance weight “2” is generated, and the number of sustain pulses that is eight times the number of sustain pulses in the subfield having the luminance weight “1” is generated. Therefore, the light emission in the subfield having the luminance weight “8” is approximately four times as high as that in the subfield having the luminance weight “2”, and approximately eight times as high as that in the subfield having the luminance weight “1”. Therefore, the selective light emission caused by the combination of the respective subfields in response to image signals allows the display of various gradations and an image.

In the sustain period of each subfield, sustain pulses based on the luminance weight of the corresponding subfield multiplied by a predetermined proportionality factor are applied to respective display electrode pairs 24. This proportionality factor is a luminance magnification.

In this exemplary embodiment, when the luminance magnification is 1, two sustain pulses are generated in the sustain period of a subfield having the luminance weight “1”, and one sustain pulse is applied to each of scan electrodes 22 and sustain electrodes 23. That is, in each sustain period, sustain pulses equal in number to the luminance weight of the corresponding subfield multiplied by a predetermined luminance magnification are applied to respective scan electrodes 22 and sustain electrodes 23. Therefore, when the luminance magnification is 2, the number of sustain pulses generated in the sustain period of a subfield having the luminance weight “1” is 4. When the luminance magnification is 3, the number of sustain pulses generated in the sustain period of a subfield having the luminance weight “1” is 6.

However, in this exemplary embodiment, the number of subfields forming one field, or the luminance weights of the respective subfields is not limited to the above values. Alternatively, the subfield structure may be switched in response to an image signal, for example.

Subfield SF1 through subfield SF5 are the subfield that emits a discharge cell corresponding to a gradation level based on an image signal so as to display an image signal. Subfield SF6 that displays oblique line interpolated data generated based on an image signal so as to suppress degradation of the display quality of moving oblique lines. This will be detailed later.

The workings of plasma display apparatus 40 described below will be focused on a case where an odd-line image signal as an interlace signal is displayed. Description on the operation for displaying an even-line image signal as an interlace signal will be omitted. The operation for displaying even-line image signals is nearly the same as that for displaying odd-line image signals except for changing the combination of scan electrodes 22 to which scan pulses are applied simultaneously.

Hereinafter, in this exemplary embodiment, a description is provided for an example where SF1, i.e. a subfield occurring first, in each of a field for the right eye and a field for the left eye is a forced initializing subfield. That is, in the initializing period of subfield SF1, a forced initializing operation is performed. In the initializing periods of the other subfields (subfields SF2 through SF6), a selective initializing operation is performed. This structure can cause an initializing discharge in all the discharge cells at least once in one field, thus stabilizing the address operation after the forced initializing operation. Further, the light emission unrelated to image display is only the light emission caused by the discharge in the forced initializing operation in subfield SF1. Thus, luminance of black level, i.e. the luminance of a black display area where no sustain discharge occurs, is reduced. Thereby, an image of high contrast can be displayed on panel 10.

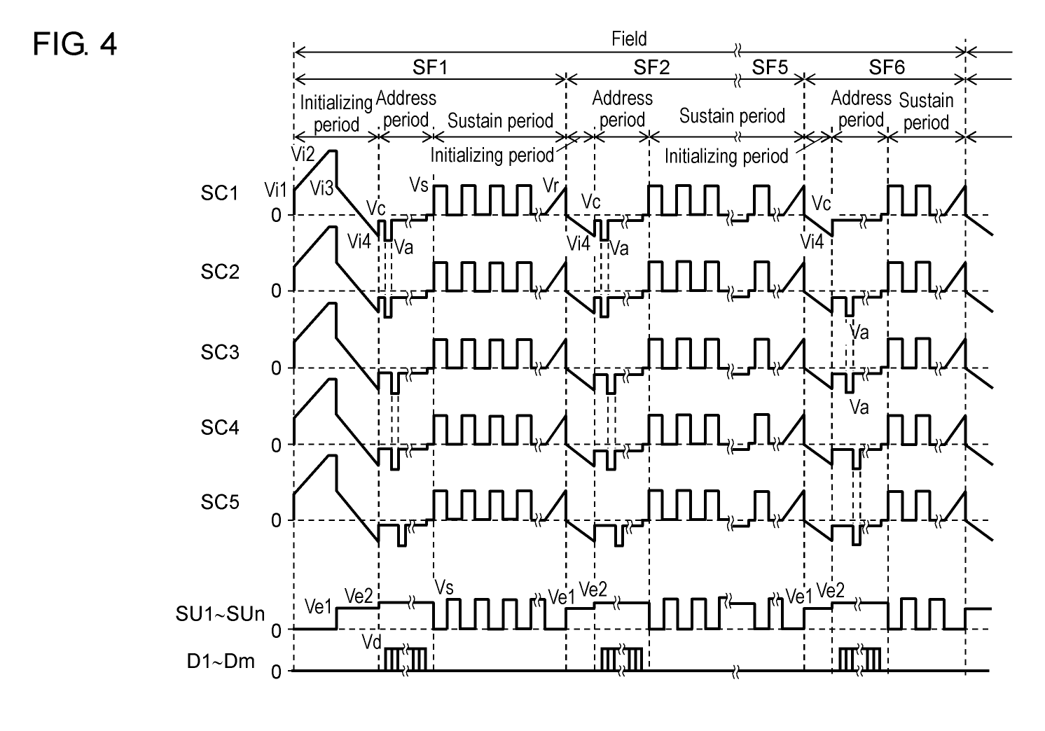

FIG. 4 is a chart of driving voltage waveforms applied to the respective electrodes of panel 10 for use in plasma display apparatus 40 in accordance with the exemplary embodiment of the present invention. FIG. 4 shows driving voltage waveforms applied to the following electrodes: scan electrodes SC1 through SC5 that undergo an address operation first in scan electrodes 22 in the address periods; sustain electrodes SU1 through SUn; and data electrodes D1 through Dm.

Scan electrode SCi, sustain electrode SUi, and data electrode Dk in the following description are the electrodes selected from the respective electrodes, based on image data (data representing the light emission and no light emission in each subfield).

First, a description is provided for subfield SF1 where all the discharge cells are initialized.

In the first half of the initializing period of subfield SF1, 0 (V) is applied to data electrodes D1 through Dm, and sustain electrodes SU1 through SUn. Voltage Vi1 is applied to scan electrodes SC1 through SCn. Voltage Vi1 is set to a voltage lower than a discharge start voltage with respect to sustain electrodes SU1 through SUn. Further, a ramp waveform voltage gently rising from voltage Vi1 toward voltage Vi2 is applied to scan electrodes SC1 through SCn. Voltage Vi2 is set to a voltage exceeding the discharge start voltage with respect to sustain electrodes SU1 through SUn.

While this ramp waveform voltage is rising, a weak initializing discharge continuously occurs between scan electrodes SC1 through SCn and sustain electrodes SU1 through SUn, and between scan electrodes SC1 through SCn and data electrodes D1 through Dm. Then, negative wall voltage accumulates on scan electrodes SC1 through SCn, and positive wall voltage accumulates on data electrodes D1 through Dm and sustain electrodes SU1 through SUn. This wall voltage on the electrodes means voltages that are generated by the wall charge accumulated on the dielectric layers covering the electrodes, the protective layer, the phosphor layers, or the like.

In the second half of the initializing period, positive voltage Ve1 is applied to sustain electrodes SU1 through SUn, and 0 (V) is applied to data electrodes D1 through Dm. A ramp waveform voltage gently falling from voltage Vi3 to negative voltage Vi4 is applied to scan electrodes SC1 through SCn. Voltage Vi3 is set to a voltage lower than the discharge start voltage with respect to sustain electrodes SU1 through SUn, and voltage Vi4 is set to a voltage exceeding the discharge start voltage.

While the falling ramp waveform voltage is applied to scan electrodes SC1 through SCn, a weak initializing discharge occurs between scan electrodes SC1 through SCn and sustain electrodes SU1 through SUn, and between scan electrodes SC1 through SCn and data electrodes D1 through Dm. This weak discharge reduces the negative wall voltage on scan electrodes SC1 through SCn and the positive wall voltage on sustain electrodes SU1 through SUn, and adjusts the positive wall voltage on data electrodes D1 through Dm to a value appropriate for the address operation. In this manner, the forced initializing operation for forcedly causing an initializing discharge in all the discharge cells is completed.

In the address period of subfield SF1, voltage Vet is applied to sustain electrodes SU1 through SUn, and voltage Vc (where voltage Vc=voltage Va+voltage Vsc) is applied to scan electrodes SC1 through SCn.

Next, a scan pulse of negative voltage Va is applied simultaneously to scan electrode SC1 in the first line and scan electrode SC2 in the second line. At the same time, in response to an image signal, an address pulse of positive voltage Vd is applied to data electrode Dk of a discharge cell to be lit in the first line in data electrodes D1 through Dm. Through the application of the address pulse, the voltage difference in the intersecting part of data electrode Dk and scan electrode SC1 and the voltage difference in the intersecting part of data electrode Dk and scan electrode SC2 exceed the discharge start voltage, and a discharge occurs between data electrode Dk and scan electrode SC1 and between data electrode Dk and scan electrode SC2.

Since voltage Ve2 is applied to sustain electrodes SU1 through SUn, the discharge occurred between data electrode Dk and scan electrode SC1 triggers a discharge between sustain electrode SU1 and scan electrode SC1 that are disposed in the area intersecting to data electrode Dk; similarly, the discharge occurred between the data electrode Dk and scan electrode SC2 triggers a discharge between sustain electrode SU2 and scan electrode SC2 that are disposed in the area intersecting to data electrode Dk.

Thus, an address discharge occurs in the discharge cell to be lit. Positive wall voltage accumulates on scan electrode SC1 and scan electrode SC2, and negative wall voltage accumulates on sustain electrode SU1 and sustain electrode SU2. Negative wall voltage also accumulates on data electrode Dk.

In this manner, address operation is performed to cause an address discharge in the discharge cells to be lit not only in the first line but also in the second line and to accumulate wall voltage on the respective electrodes. On the other hand, because of no application of address pulses, each voltage of the intersecting part of scan electrode SC1 and data electrodes 32 and of the intersecting part of scan electrode SC2 and data electrodes 32 does not exceed the discharge start voltage, and thus no address discharge occurs.

Next, scan pulses are applied simultaneously to scan electrode SC3 in the third line and scan electrode SC4 in the fourth line. Further, in response to an image signal, an address pulse is applied to data electrode Dk of a discharge cell to be lit in the third line in data electrodes D1 through Dm. This operation causes an address discharge not only in a discharge cell to be lit in the third line but also in a discharge cell to be lit in the fourth line.

Thereafter, scan pulses are applied simultaneously to scan electrode SCp (where, p is an odd number) in an odd line and scan electrode SCp+1 in the next (i.e., even) line, and the address operation similar to the above is sequentially repeated until the operation reaches scan electrode SCn. Further, in response to an image signal, an address pulse is applied to data electrode Dk of a discharge cell to be lit in the p-th line in data electrodes D1 through Dm. Thus, the address operation is completed.

In this manner, in this exemplary embodiment, the two-line simultaneous address operation is performed in the address period. Compared to the address operation line by line, the two-line simultaneous address operation nearly halves the time required for the address operation.

The description above is focused on a case where an odd-line image signal as an interlace signal is displayed. In a case where an even-line image signal as an interlace signal is displayed, the two-line simultaneous address operation is performed as follows: scan pulses are applied simultaneously to scan electrode SCp+1 in an even line and scan electrode SCp+2 in the next odd line; further, in response to an image signal, an address pulse is applied to data electrode Dk of a discharge cell to be lit in the p+1-th line.

In the subsequent sustain period, sustain pulses are alternately applied to display electrode pairs 24. This causes a sustain discharge in the discharge cells having undergone the address discharge, and the discharge cells to emit light.

In this sustain period, first, sustain pulses of positive voltage Vs are applied to scan electrodes SC1 through SCn, and a ground electric potential as a base electric potential, i.e. 0 (V), is applied to sustain electrodes SU1 through SUn. Then, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs and the wall voltage at the completion of the initializing period is maintained.

Subsequently, voltage 0 (V) as the base electric potential is applied to scan electrodes SC1 through SCn, and sustain pulses are applied to sustain electrodes SU1 through SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses are alternately applied to scan electrodes SC1 through SCn and sustain electrodes SU1 through SUn. The number of sustain pulses applied to the electrodes above corresponds to a number calculated by multiplying the luminance weight by a predetermined luminance magnification. Thereby, the sustain discharge is continued in the discharge cells having undergone the address discharge in the address period.

After the sustain pulses have been generated in the sustain period, a ramp waveform voltage gently rising from 0 (V) toward voltage Vr is applied to scan electrodes SC1 through SCn while 0 (V) is applied to sustain electrodes SU1 through SUn and data electrodes D1 through Dm. Voltage Vr set to a voltage exceeding the discharge start voltage causes a weak discharge between sustain electrode SUi and scan electrode SCi in the discharge cell having undergone a sustain discharge. The charged particles generated by this weak discharge accumulate on sustain electrode SUi and scan electrode SCi so as to reduce the voltage difference between sustain electrode SUi and scan electrode SCi. Thereby, in the discharge cells having undergone the sustain discharge, a part or the whole of the wall voltage on scan electrode SCi and sustain electrode SUi is erased while the positive wall charge is left on data electrode Dk.

After the rising voltage has reached voltage Vr, the voltage applied to scan electrodes SC1 through SCn is lowered to voltage 0 (V). Thus, the sustain operation in the sustain period is completed.

Next, a description is provided for subfield SF2 as a selective initializing subfield.

In the initializing period of subfield SF2, voltage Ve1 is applied to sustain electrodes SU1 through SUn, and 0 (V) is applied to data electrodes D1 through Dm. A ramp waveform voltage gently falling from a voltage (e.g. voltage 0 (V)) lower than the discharge start voltage toward negative voltage Vi4 exceeding the discharge start voltage is applied to scan electrodes SC1 through SCn.

With this voltage application, a weak initializing discharge occurs in the discharge cells having undergone a sustain discharge in the sustain period of the immediately preceding subfield (subfield SF1 in FIG. 4). This weak discharge reduces the wall voltage on scan electrode SCi and sustain electrode SUi. Since sufficient positive wall voltage is accumulated on data electrode Dk by the immediately preceding sustain discharge, the excess part of this wall voltage is discharged and is adjusted to a value appropriately for the address operation.

In contrast, in the discharge cells having undergone no sustain discharge in the sustain period of the immediately preceding subfield, no initializing discharge occurs, and the wall charge at the completion of the initializing period of the immediately preceding subfield is maintained. In this manner, in the initializing operation in subfield SF2, a selective initializing operation is performed so as to cause an initializing discharge in the discharge cells having undergone an address operation in the address period of the immediately preceding subfield, i.e. in the discharge cells having undergone a sustain discharge in the sustain period of the immediately preceding subfield.

The address operation in the subsequent address period of subfield SF2 is the same as that performed in the address period of subfield SF1. That is, scan pulses are applied simultaneously to scan electrode SCp in an odd line and scan electrode SCp+1 in the next even line. At the same time, an address pulse is applied to data electrode Dk of a discharge cell to be lit in the p-th line in data electrodes D1 through Dm. The two-line simultaneous address operation is thus performed.

The operation in the subsequent sustain period of subfield SF2 is nearly the same as that performed in the address period of subfield SF1 except for the number of sustain pulses. Further, each operation in the subsequent subfield SF3 through subfield SF5 is nearly the same as that performed in subfield SF2 except for the number of sustain pulses.

Subfield SF6, which is the last subfield of one field, displays oblique line interpolated data. Like in the initializing period of subfield SF2, the selective initializing operation is performed in the initializing period of subfield SF6, and the description thereof is omitted.

In the address period of subfield SF6, voltage Vet is applied to sustain electrodes SU1 through SUn, and voltage Vc is applied to each of scan electrode SC1, scan electrode SC2, . . . , scan electrode SCn.

According to the embodiment, there is no oblique line interpolated data in the first line, and therefore no address operation is performed in the first line of address period of subfield SF6. Next, sustain pulses of negative voltage Va are applied simultaneously to scan electrode SC2 in the second line and scan electrode SC3 in the third line. Further, according to the oblique line interpolated data, an address pulse of positive voltage Vd is applied to data electrode Dk of a discharge cell to be lit in the second and the third lines.

Thus, the voltage difference in the intersecting part of data electrode Dk and scan electrode SC2 and the voltage difference in the intersecting part of data electrode Dk and scan electrode SC3 in the discharge cells applied with the address pulse exceed the discharge start voltage. Thus, an address discharge occurs between data electrode Dk, scan electrode SC2, and sustain electrode SU2, and between data electrode Dk, scan electrode SC3, and sustain electrode SU3. Through the address discharge, positive wall voltage accumulates on scan electrode SC2 and scan electrode SC3, whereas negative wall voltage accumulates on sustain electrode SU2, sustain electrode SU3, and data electrode Dk.

In this manner, the address operation is performed. That is, according to the oblique line interpolated data, an address discharge is caused in the discharge cell to be lit in the second and the third lines, by which wall voltage accumulates on each electrode. On the other hand, in the intersecting part of data electrodes 32 and scan electrode SC2 and in the intersecting part of data electrodes 32 and scan electrode SC3, both the intersecting parts have no application of address pulse, the voltage does not exceed the discharge start voltage. Thus, no address discharge occurs.

Next, a scan pulse is applied simultaneously to scan electrode SC4 in the fourth line and scan electrode SC5 in the fifth line. Further, according to oblique line interpolated data, an address pulse is applied to data electrode Dk of a discharge cell to be lit in the fourth and the fifth lines in data electrodes D1 through Dm. In this manner, an address discharge occurs in the discharge cell to be lit.

In a manner similar to above, a scan pulse is applied simultaneously to scan electrode SCp+1 in an even line and scan electrode SCp+2 in the next odd line. In this way, an address operation is repeated until the operation reaches scan electrode SCn−1.

The description above does not refer to the address operation on scan electrode SC1 in the first line and scan electrode SCn in the n-th line. As necessary, the address operation may be individually performed for scan electrode SC1 and scan electrode SCn.

Besides, the description above is focused on the address operation of subfield SF6 where the image signal to be displayed is an odd-line interlace signal. In the address operation of subfield SF6 where the image signal to be displayed is an even-line interlace signal, scan pulses are applied simultaneously to scan electrode SCp in an odd line and scan electrode SCp+1 in the next even line.

The operation in the sustain period of subfield SF6 is similar to that in each sustain period of subfield SF1 through subfield SF5 except for the number of sustain pulses.

The above description has outlined the driving voltage waveforms applied to the respective electrodes of panel 10 in this exemplary embodiment.

The voltage to be applied to the respective electrodes in this exemplary embodiment includes the following values: voltage Vi1=145 (V); voltage Vi2=335 (V); voltage Vi3=190 (V); voltage Vi4=−160 (V); voltage Va=−180 (V); voltage Vc=−35 (V); voltage Vs=190 (V); voltage Vr=190 (V); voltage Ve1=125 (V); voltage Ve2=130 (V); and voltage Vd=60 (V). However, these voltage values are only examples. Preferably, each of the voltage values is set appropriate for the characteristics of panel 10, the specifications of plasma display apparatus 40, or the like. For example, voltage Ve1 and voltage Vet may be equal, and voltage Vc may be at a positive value.

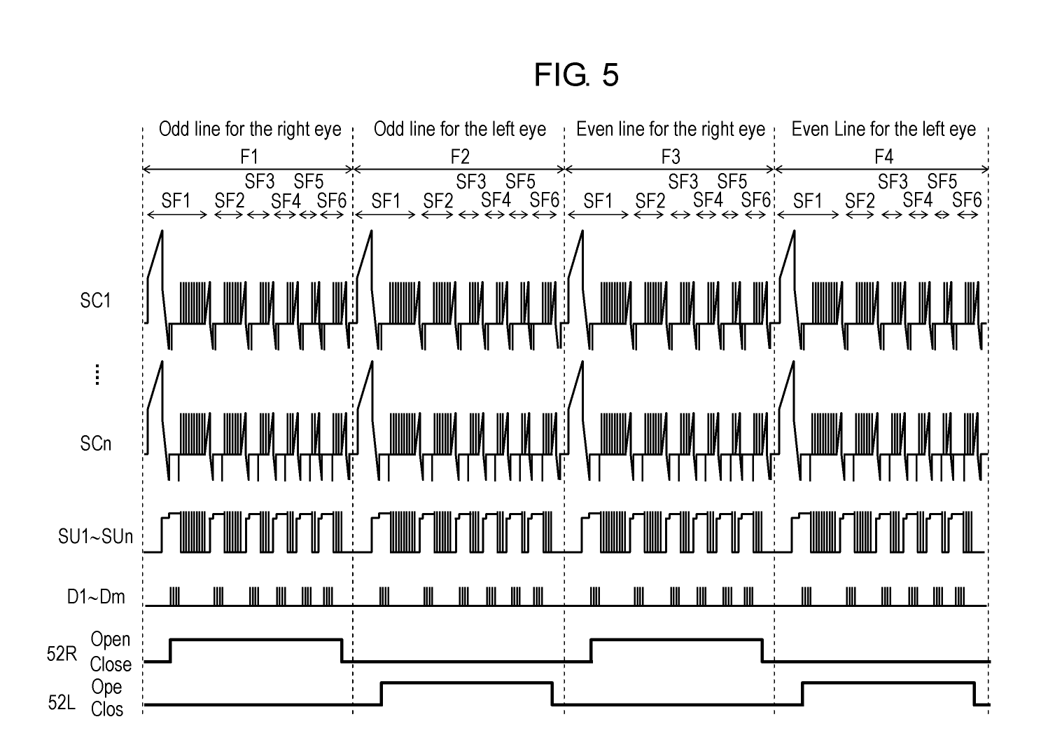

Next, the subfield structure of plasma display apparatus 40 of this exemplary embodiment is described again. FIG. 5 is a schematic diagram showing a subfield structure of plasma display apparatus 40 and an opening/closing operation of pair of shutter glasses 50 in accordance with the exemplary embodiment of the present invention. FIG. 5 shows driving voltage waveforms applied to scan electrode SC1 for undergoing an address operation first in the address periods, scan electrode SCn for undergoing an address operation last in the address periods, sustain electrodes SU1 through SUn, and data electrodes D1 through Dm, together with an opening/closing operation of right eye shutter 52R and left eye shutter 52L. FIG. 5 also shows four fields (fields F1 through F4).

In this exemplary embodiment, in order to display a 3D image on panel 10, a field for the right eye and a field for the left eye are alternately generated.

For example, out of four fields shown in FIG. 5, field F1 and field F3 are the fields for the right eye, whereas field F2 and field F4 are the fields for the left eye. Field F1 displays an odd-line image signal for the right eye, and field F3 displays an even-line image signal for the right eye on panel 10. Field F2 displays an odd-line image signal for the left eye, and field F4 displays an even-line image signal for the left eye.

Specifically, each of field F1 through field F4 undergoes the following address operations.

Field 1: in subfield SF1 through subfield SF5, scan pulses are applied simultaneously to scan electrode SCp in an odd line and scan electrode SCp+1 in the next even line, and in subfield SF6, scan pulses are applied simultaneously to scan electrode SCp+1 in the even line and scan electrode SCp+2 in the next odd line.

Field 2: in subfield SF1 through subfield SF5, scan pulses are applied simultaneously to scan electrode SCp in the odd line and scan electrode SCp+1 in the next even line, and in subfield SF6, scan pulses are applied simultaneously to scan electrode SCp+1 in the even line and scan electrode SCp+2 in the next odd line.

Field 3: in subfield SF1 through subfield SF5, scan pulses are applied simultaneously to scan electrode SCp+1 in the even line and scan electrode SCp+2 in the next odd line, and in subfield SF6, scan pulses are applied simultaneously to scan electrode SCp in the odd line and scan electrode SCp+1 in the next even line.

Field 4: in subfield SF1 through subfield SF5, scan pulses are applied simultaneously to scan electrode SCp+1 in the even line and scan electrode SCp+2 in the next odd line, and in subfield SF6, scan pulses are applied simultaneously to scan electrode SCp in the odd line and scan electrode SCp+1 in the next even line.

The user who views a 3D image displayed on panel 10 through pair of shutter glasses 50 perceives images shown in two fields (an image for the right eye and an image for the left eye) as one 3D image. Thus, the user perceives the number of images displayed on panel 10 per second as a half the number of fields displayed per second. For instance, when the field frequency of 3D images displayed on panel (the number of fields generated per second) is 60 Hz, the user perceives thirty 3D images per second. Therefore, in order to display sixty 3D images per second, the field frequency needs to be set to 120 Hz, which is twice of 60 Hz. Then, in this exemplary embodiment, the field frequency (the number of fields generated per second) is set to twice (e.g. 120 Hz) the ordinary field frequency so that the user can perceive a smooth 3D moving image. Therefore, the time required for displaying one image for the right eye or one image for the left eye is limited to the half the time for displaying one 2D image (i.e., a non-3D ordinary image).

The opening/closing operation of right eye shutter 52R and left eye shutter 52L of pair of shutter glasses 50 is controlled in response to the ON/OFF of the shutter opening/closing timing signal output from timing signal output part 46. Specifically, in field F1 for the right eye, right eye shutter 52R opens in synchronization with the start of the address period of subfield SF1 and closes in synchronization with the completion of the sustain period of subfield SF6. In field F2 for the left eye, left eye shutter 52L opens in synchronization with the start of the address period of subfield SF1 and closes in synchronization with the completion of the sustain period of subfield SF6. Similarly, in field F3 for the right eye, right eye shutter 52R opens in synchronization with the start of the address period of subfield SF1 and closes in synchronization with the completion of the sustain period of subfield SF6. In field F4 for the left eye, left eye shutter 52L opens in synchronization with the start of the address period of subfield SF1 and closes in synchronization with the completion of the sustain period of subfield SF6.

Next, the oblique line interpolation circuit and the workings of the circuit of plasma display apparatus 40 in the embodiment will be described.

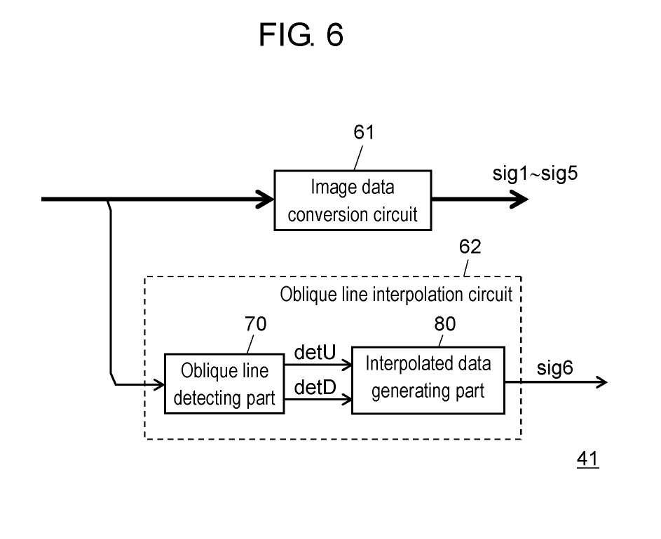

FIG. 6 is a circuit block diagram showing image signal processing circuit 41 of plasma display apparatus 40 in accordance with the first exemplary embodiment. Image signal processing circuit 41 has image data conversion circuit 61 and oblique line interpolation circuit 62. Image signal processing circuit 41 is disposed individually for processing red image signals, green image signals, and blue image signals, and each of which has a similar structure and workings. The circuit structure and workings of image signal processing circuit 41 will be detailed below, focusing on one color of the three.

Image data conversion circuit 61 receives an image signal and converts it into image data as digital signals of 1 and 0 that correspond to light emission and no light emission, respectively, of each discharge cell in subfield SF1 through subfield SF5. According to the embodiment, the input image signal is an interlace signal, and the output image data is 5-bit digital data. Each bit (bit sig1 through bit sig5) of 1 or 0 represents light emission or no light emission of each discharge cell in subfield SF1 through subfield SF5. Digital data of 1 represents light emission, whereas digital data of 0 represents no light emission.

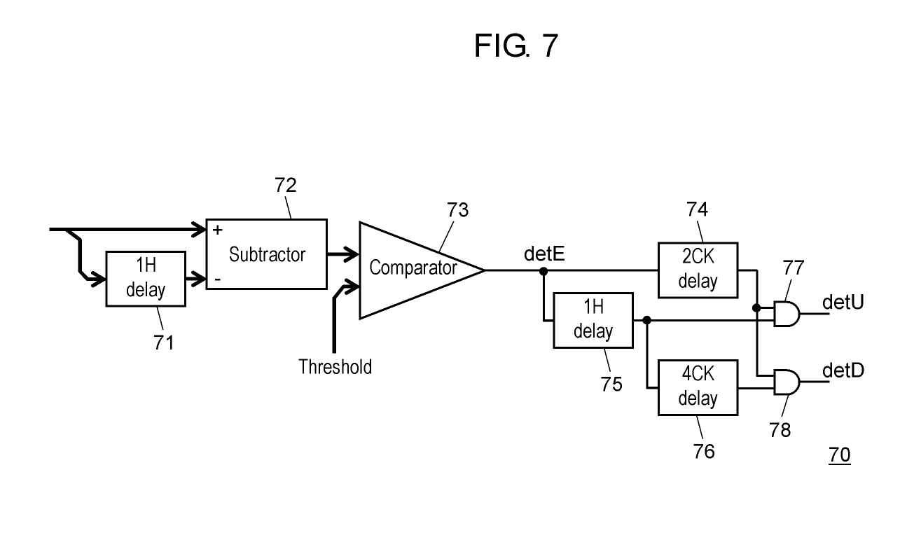

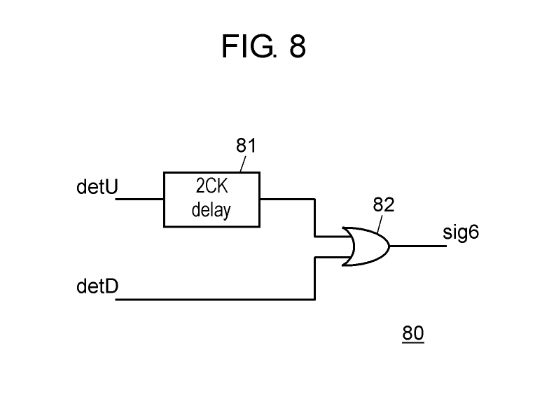

Oblique line interpolation circuit 62 has oblique line detecting part 70 and interpolated data generating part 80. FIG. 7 is a circuit block diagram showing oblique line detecting part 70 of plasma display apparatus 40 of the first exemplary embodiment. FIG. 8 is a circuit block diagram showing interpolated data generating part 80 of plasma display apparatus 40 of the embodiment.

Oblique line detecting part 70 has 1Hdelay 71, subtractor 72, comparator 73, 2CKdelay 74, 1Hdelay 75, 4CKdelay 76, AND gate 77, and AND gate 78.

1Hdelay 71 delays an image signal for one horizontal blanking interval (one horizontal synchronization interval). Subtractor 72 subtracts the image signal having undergone one horizontal blanking interval delay from the input image signal and ontputs the result. That is, subtractor 72 provides subtraction between the image signals corresponding to adjacent pixels in the vertical direction. The subtracted result is a positive or negative numeric value. Comparator 73 compares the output from subtractor 72 with a predetermined threshold and outputs the comparison result as “edge detection signal detE”. In the embodiment, if the output of subtractor 72 is equal to or greater than the threshold, comparator 73 outputs 1; otherwise, outputs 0. That is, 1Hdelay 71, subtactor 72, and comparator 73 form the circuit that detects pixels corresponding to the contours of a display image from image signals.

2CKdelay 74 delays edge detection signal detE for 2 pixels. 1Hdelay 75 delays edge detection signal detE for one horizontal blanking interval. 4CKdelay 76 further delays the edge detection signal detE having undergone one horizontal blanking interval delay for 4 pixels. AND gate 77 offers logical AND operation between the edge detection signal detE having undergone 2-pixel delay and the edge detection signal detE having undergone one horizontal blanking interval delay. Only if both of the edge detection signals detE having undergone 2-pixel delay and the edge detection signal detE having undergone one horizontal blanking interval delay are 1, AND gate outputs 1; otherwise outputs 0. AND gate 77 outputs the result of the logical AND operation as “upward oblique line detection signal detU”. AND gate 78 offers logical AND operation between the edge detection signal detE having undergone 2-pixel delay and the edge detection signal detE having undergone one horizontal blanking interval plus 4-pixel delay. Only if both of the edge detection signals detE having undergone 2-pixel delay and the edge detection signal detE having undergone one horizontal blanking interval plus 4-pixel delay are 1, AND gate 78 outputs 1; otherwise outputs 0. AND gate 78 outputs the result of the logical AND operation as “downward oblique line detection signal detD”.

Interpolated data generating part 80 has 2CKdelay 81 and OR gate 82. 2CKdelay 81 delays upward oblique line detection signal detU fed from AND gate 77 for 2 pixels. OR gate 82 offers logical sum operation between upward oblique line detection signal detU having undergone 2-pixel delay and downward oblique line detection signal detD fed from AND gate 78. If both the signals are 0, OR gate 82 outputs 0. If at least any one of the signals is 1, OR gate 82 outputs 1. OR gate 82 outputs the result of the logical sum operation as “oblique line interpolated data sig6”.

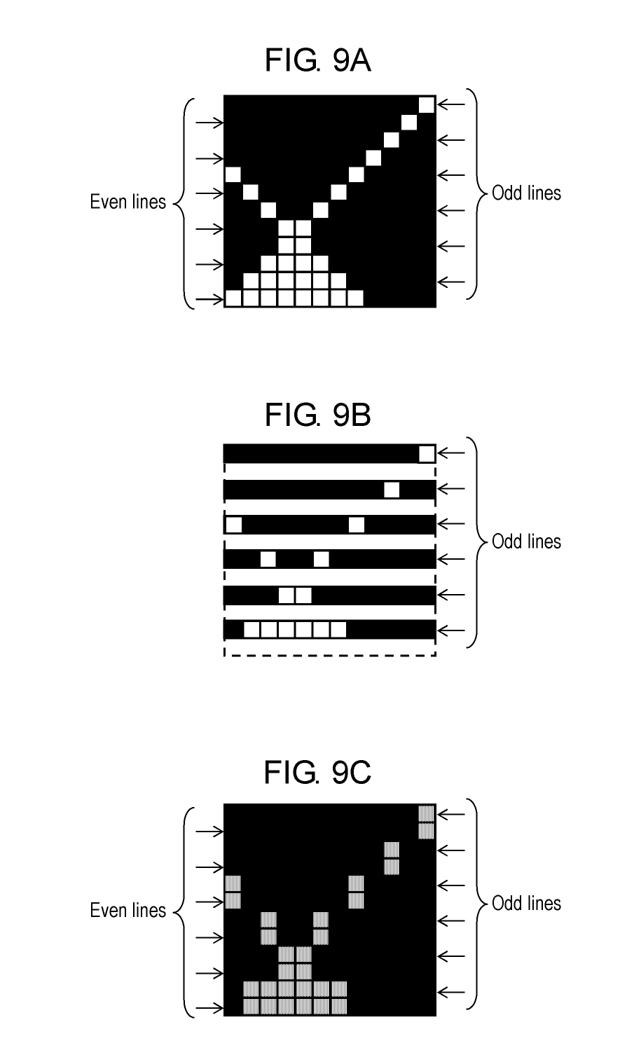

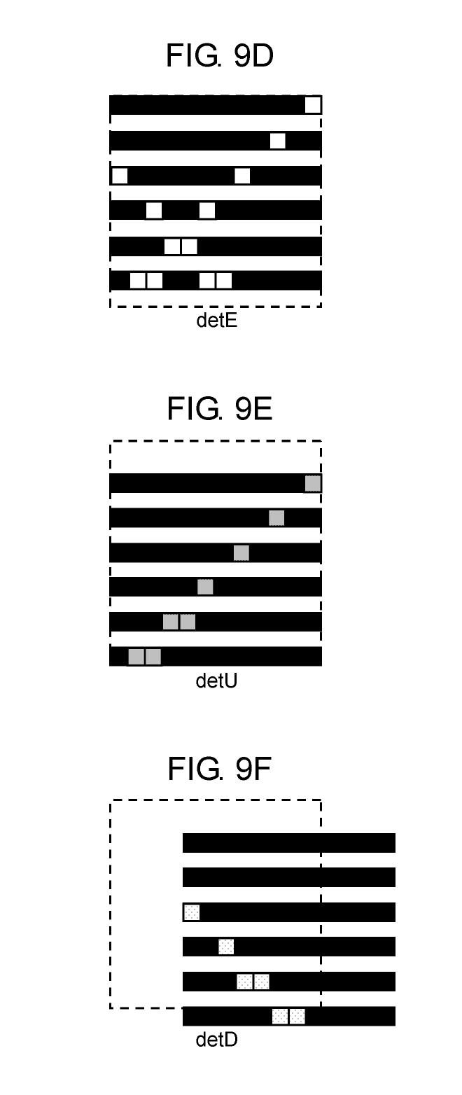

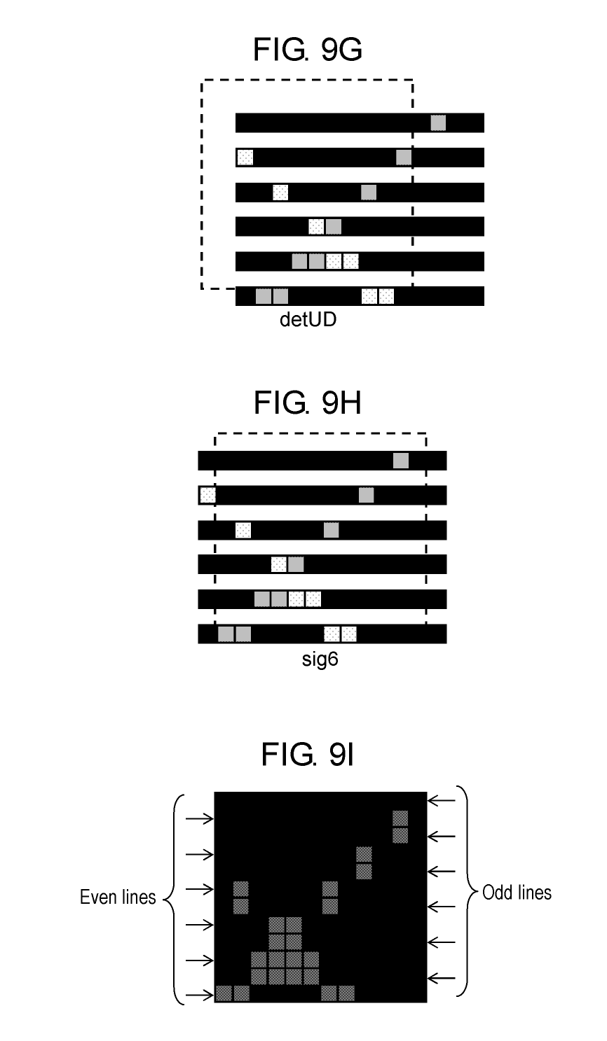

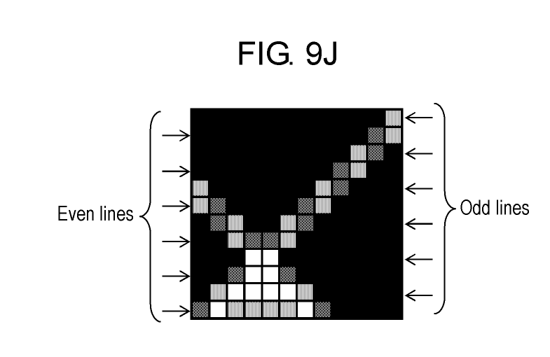

Next, the workings of oblique line interpolation circuit 62 will be described. FIG. 9A through FIG. 9J illustrate the workings of oblique line interpolation circuit 62 of plasma display apparatus 40 in accordance with the first exemplary embodiment. The description below is given on an example in which the panel displays the image shown in FIG. 9A. According to the embodiment, as described earlier, the input image signal is an interlace signal. That is, one image is displayed as divided two images of the odd-line image and the even-line image. FIG. 9A shows a part of an enlarged image formed of the odd-line image and the even-line image. Out of the image signals shown in FIG. 9A, for example, image signals for displaying an odd-line image contain odd-line image data only, as shown in FIG. 9B.

According to the embodiment, in subfield SF1 through subfield SF5, the two-line simultaneous address operation—where scan pulses are applied simultaneously to scan electrode SCp in the odd line and scan electrode SCp+1 in the next even line—is performed. Therefore, the discharge cell positioned at scan electrode SCp in the odd line and the discharge cell positioned at scan electrode SCp+1 in the next even line have emission in the same pattern. As a result, the image displayed on panel 10 has poor vertical resolution, as shown in FIG. 9C.

Subtractor 72 of oblique line interpolation circuit 62 subtracts an image signal having undergone one horizontal blanking interval delay from the image signal shown in FIG. 9B. In other words (on the aspect of the pixels disposed on panel 10), subtractor 72 subtracts the image signal of a pixel disposed vertically two-pixel above, with respect to the image signal of a pixel to be calculated, from the image signal of the pixel to be calculated. If the gradation value of a pixel to be calculated is equal to or higher than the threshold than the gradation value of a pixel disposed vertically two-pixel above, comparator 73 outputs edge detection signal detE of 1. For example, in response to the image signal shown in FIG. 9B, comparator 73 outputs edge detection signal detE as shown in FIG. 9D.

AND gate 77 of oblique line interpolation circuit 62 offers logical AND operation between edge detection signal detE having undergone 2-pixel delay and edge detection signal detE having undergone one horizontal blanking interval delay. As the result of the logical AND operation, AND gate 77 outputs upward oblique line detection signal detU. In other words (on the aspect of the pixels disposed on panel 10), when the pixel to be calculated has edge detection signal detE of 1 and the pixel positioned at 2-pixel rightward in the horizontal direction and at 2-pixel upward in the vertical direction with reference to the 2-pixel delayed signal has edge detection signal detE of 1, AND gate 77 outputs upward oblique line detection signal detU of 1. Therefore, on the aspect of the pixels disposed on panel 10, upward oblique line detection signal detU is set to 1 at the pixel that constitutes an upward oblique line. For example, in response to edge detection signal detE shown in FIG. 9D, upward oblique line detection signal detU of FIG. 9E is obtained. AND gate 78 of oblique line interpolation circuit 62 offers logical AND operation between edge detection signal detE having undergone 2-pixel delay and edge detection signal detE having undergone one horizontal blanking interval delay plus 4-pixel delay. As the result of the logical AND operation, AND gate 78 outputs downward oblique line detection signal detD. In other words (on the aspect of the pixels disposed on panel 10), when the pixel to be calculated has edge detection signal detE of 1 and the pixel positioned at 2-pixel leftward in the horizontal direction and at 2-pixel upward in the vertical direction with reference to the 2-pixel delayed signal has edge detection signal detE of 1, AND gate 78 outputs downward oblique line detection signal detD of 1. Therefore, on the aspect of the pixels disposed on panel 10, downward oblique line detection signal detD is set to 1 at the pixel that constitutes a downward oblique line. For example, in response to edge detection signal detE shown in FIG. 9D, downward oblique line detection signal detD of FIG. 9F is obtained.

OR gate 82 of interpolated data generating part 80 offers logical sum operation between downward oblique line detection signal detD and upward oblique line detection signal detU having undergone 2-pixel delay. As the result of the logical sum operation, OR gate 82 outputs logical sum detUD. For example, from upward oblique line detection signal detU (of FIG. 9E) and downward oblique line detection signal detD (of FIG. 9F), OR gate 82 outputs logical sum detUD as the result of the operation of FIG. 9G.

Further, logical sum detUD is vertically moved one-line above and is horizontally moved three-pixel left (where, detUD is represented as the pixel disposed on panel 10) so as to obtain oblique line interpolated data sig6 as an even-line interlace signal. The delay circuit is not shown in FIG. 8. For example, from logical sum detUD of FIG. 9G, oblique line interpolated data sig6 of FIG. 9H is obtained.

Oblique line interpolated data sig6 is used for emission/non-emission control in subfield SF6. That is, according to oblique line interpolated data sig6, the two-line simultaneous address operation is performed in the address period of subfield SF6. For example, FIG. 9I shows emission/non-emission of subfield SF6 when oblique line interpolated data sig6 of FIG. 9H is employed.

Suppose that, for example, image signals containing odd-line image data only are displayed on panel 10. According to the example of FIG. 9B, subfield SF1 through subfield SF5 display the image shown in FIG. 9C, while subfield SF6 displays the image shown in FIG. 9I. That is, compared to the image of FIG. 9C (displayed by subfield SF1 through subfield SF5), the image of FIG. 9J displayed by all the subfields from subfield SF1 to subfield SF6 enhances vertical resolution.

Here, suppose that the image on panel 10 is displayed only by subfield SF1 through subfield SF5 having the two-line simultaneous address operation. In that case, the image for one field has poor vertical resolution, as shown in FIG. 9C. If it is a still image, interpolation by image signals for displaying even-line image in the next field suppresses decrease in vertical resolution. However, if the image is a moving image, a viewer perceives the image of the field as it is. Especially, when the image contains an oblique line moving at a speed, the viewer perceives the oblique line as a divided pattern, as shown in FIG. 9C, not as being linear. As a result, the quality of image display on panel 10 is considerably degraded.

However, the structure of the embodiment has a subfield for displaying oblique line interpolated data in one field. According to an image signal, an oblique line is detected, and oblique line interpolated data is generated based on the detection. Such generated oblique line interpolated data is displayed by using the subfield that displays the oblique line interpolated data, allowing panel 10 to display image having undergone oblique line interpolation. As described earlier, the two-line simultaneous address operation shortens the time required for address period; on the other hand, it can degrade vertical resolution. According to the structure of the embodiment, however, the two-line simultaneous address operation is performed in the address period of each subfield, while panel 10 displays image with degradation of image display quality suppressed. The structure of the embodiment not only shortens the time required for the address period but also suppresses the degradation of image display quality.

In the example described in this exemplary embodiment, subfield SF6 has a luminance weight of 8, but it is not limited to. The luminance weight of the subfield for displaying oblique line interpolated data may be a numerical value other than 8. As another possibility, the luminance weight may be determined on the average luminance of an oblique line to be interpolated. In that case, the luminance weight is set to be larger as the calculated average luminance has a higher value.

### Second Exemplary Embodiment

In the first exemplary embodiment, description is given on an example where the address period of subfield SF6 for displaying oblique line interpolated data has the two-line simultaneous address operation. However, the present invention is not limited to the structure above. Hereinafter, the description will be given on an example where the address period of the subfield for displaying oblique line interpolated data has an address operation line by line, instead of the two-line simultaneous address operation.

The panel and the circuit block in the second embodiment are similar to panel 10 and the circuit block of plasma display apparatus 40 in the first embodiment. The structure of the second embodiment differs from that of the first embodiment in the oblique line interpolated data and the structure of the subfield for displaying the data.

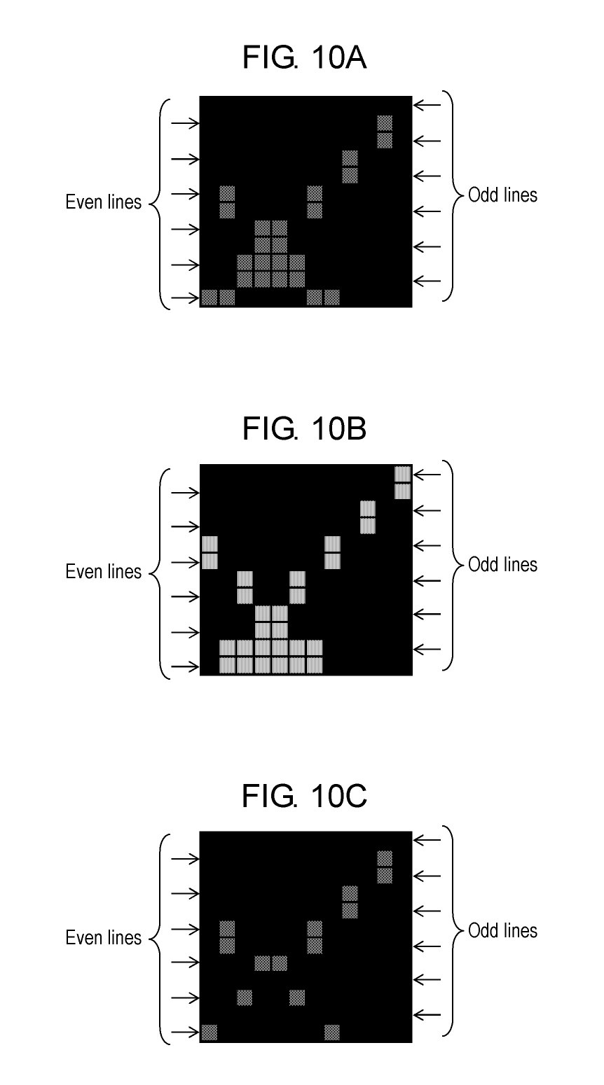

FIGS. 10A through 10C illustrate the oblique line interpolated data of the plasma display apparatus of the second exemplary embodiment of the present invention.

First, as is similar to the example described in the first embodiment, logical sum detUD is vertically moved one-line above and is horizontally moved three-pixel left (where, detUD is represented as the pixel disposed on panel 10) so as to generate oblique line interpolated data sig6 as an even-line interlace signal.

In the embodiment, oblique line interpolated data sig6 for an even line also serves as oblique line interpolated data sig6 for the next odd line. That is, according to the embodiment, oblique line interpolated data sig6 for an even line is the same as that for the next odd line, as shown in FIG. 10A. However, oblique line interpolated data sig6 of FIG. 10A is not displayed as it is in the subfield for displaying oblique line interpolated data.

As is the same with FIG. 9C, FIG. 10B shows display image formed by the two-line simultaneous address operation performed in the address period of subfield SF1 through subfield SF5 with respect to the odd-line image.

In the embodiment, oblique line interpolated data sig6 is set to 0 (corresponding to no light emission) at a pixel that displays higher than a predetermined gradation level in subfield SF1 through subfield SF5. Thus, oblique line interpolated data sig6′ is generated as shown in FIG. 10C as an example.

According to oblique line interpolated data sig6′, the address operation is performed in the address period of subfield SF6. The address operation at that time (i.e. in the address period of subfield SF6) is performed line by line, instead of the two-line simultaneous address operation employed in the first embodiment. As described above, oblique line interpolated data sig6 for a pixel that displays higher than a predetermined gradation level in subfield SF1 through subfield SF5 is set to 0. Therefore, the pixel has no light emission in subfield SF6 for displaying oblique line interpolated data.

That is, a pixel that displays higher than a predetermined gradation level in subfield SF1 through subfield SF5 has no light emission in subfield SF6. This setting prevents an excess of oblique line interpolation, providing image display with realistic movement.

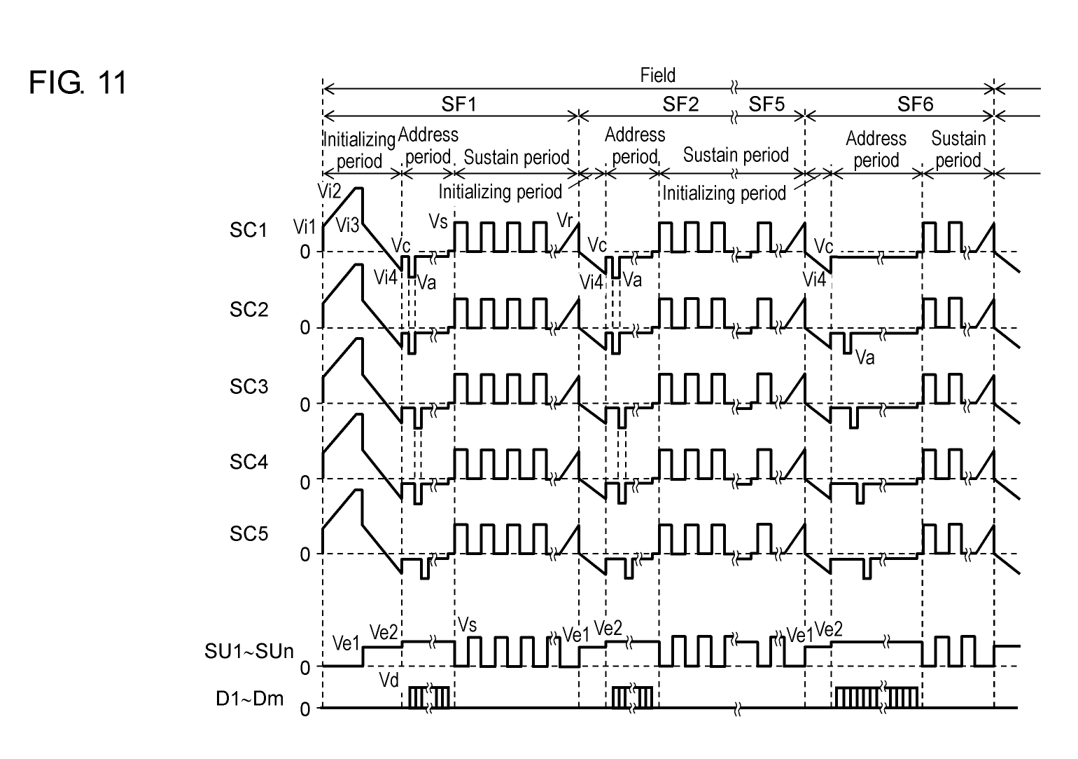

FIG. 11 is a chart of driving voltage waveforms applied to respective electrodes of the panel used for the plasma display apparatus of the embodiment. In the embodiment, the operations in subfield SF1 through subfield SF5 and the operation in the initializing period of subfield SF6 are the same as the structure in the first embodiment, and the descriptions thereof will be omitted.

In the address period of subfield SF6, voltage Ve2 is applied to sustain electrodes SU1 through SUn, while voltage Vc is applied to scan electrodes SC1 through SCn. There is no oblique line interpolated data for the first line, and accordingly, the address period of subfield SF6 has no address operation in the discharge cells in the first line.

Next, a scan pulse of negative voltage Va is applied to scan electrode SC2 in the second line. According to oblique line interpolated data sig6′ shown in FIG. 10C, an address pulse of positive voltage Vd is applied to data electrode Dk at a discharge cell to be lit in the second line so as to generate an address discharge between data electrode Dk, scan electrode SC2, and sustain electrode SU2. Next, a scan pulse of negative voltage Va is applied to scan electrode SC3 in the third line. According to oblique line interpolated data sig6′ shown in FIG. 10C, an address pulse of positive voltage Vd is applied to data electrode Dk at a discharge cell to be lit in the third line so as to generate an address discharge between data electrode Dk, scan electrode SC3, and sustain electrode SU3. Hereinafter, the address operation is performed line by line by applying scan pulses sequentially to each of scan electrodes 22 until the operation reaches scan electrode SCn.

In this manner, according to the embodiment, the time required for the address period is shortened by the two-line simultaneous address operation performed in subfield SF1 through subfield SF5; at the same time, oblique line interpolated data sig6′ of FIG. 10C is displayed by employing the address operation performed line by line in subfield SF6. The structure of the embodiment shortens the time required for the address period, while suppressing degradation of image display quality. In addition, the structure of the embodiment prevents an excess of oblique line interpolation, providing image display with realistic movement.

The description in the exemplary embodiments focuses on the workings for displaying the odd-line image. As for the case of displaying the even-line image, it is nearly the same with the case of displaying the odd-line image, except for exchanging between the odd line and the even line in the description on displaying the odd-line image.

In the exemplary embodiments, oblique line interpolated data sig6 and oblique line interpolated data sig6′ are calculated according to the gradation value of luminance of each pixel. However, the present invention is not limited to the structure above. For example, the calculation for obtaining the oblique line interpolated data may be based on the average of the gradation value of the three colors of red, blue and green calculated for each pixel.

In the example of the structure described in this exemplary embodiment, each of the field for the right eye and the field for the left eye is formed of six subfields. However, the number of subfields in the present invention is not limited to the above numerical values. If the number of subfields is increased to seven or larger, for example, the number of gradations displayable on panel 10 can be further increased. The number of subfields forming each field may be set appropriately for the specifications of plasma display apparatus 40, for example.

The driving voltage waveforms in FIG. 4 and FIG. 11 only show an example in the exemplary embodiments of the present invention. The present invention is not limited to these driving voltage waveforms.

Each circuit block shown in the exemplary embodiments of the present invention may be formed as an electric circuit that performs each operation shown in the exemplary embodiment, or formed of a microcomputer programmed so as to perform the similar operation, for example.

In the example described in the exemplary embodiments, one pixel is formed of discharge cells of R, G, and B three colors. Also a panel that includes discharge cells that form a pixel of four or more colors can use the configuration shown in this exemplary embodiment and provide the same advantage.

The specific numerical values shown in the exemplary embodiments of the present invention are set based on the characteristics of panel 10 that has a 50-inch screen and 1080 display electrode pairs 24, and simply show examples in the exemplary embodiment. The present invention is not limited to these numerical values. Preferably, each numerical value is set optimally for the characteristics of the panel, the specification of the plasma display apparatus, or the like. Variations are allowed for each numerical value within the range in which the above advantages can be obtained. Further, the number of subfields, the luminance weights of the respective subfields, or the like is not limited to the values shown in the exemplary embodiments of the present invention. The subfield structure may be switched based on image signals, for example.

### INDUSTRIAL APPLICABILITY

The present invention can shorten the time required for the address period while suppressing degradation of image display quality in a plasma display apparatus usable as a 3D image display apparatus. Thus, the present invention is useful as a plasma display apparatus driving method, a plasma display apparatus, and a plasma display system.

### REFERENCE MARKS IN THE DRAWINGS

10 panel
21 front substrate
22 scan electrode
23 sustain electrode
24 display electrode pair
25, 33 dielectric layer
26 protective layer
31 rear substrate
32 data electrode
34 barrier rib
35 phosphor layer
40 plasma display apparatus
41 image signal processing circuit
42 data electrode driver circuit
43 scan electrode driver circuit
44 sustain electrode driver circuit
45 timing generation circuit
46 timing signal output part
50 pair of shutter glasses
52R right eye shutter
52L left eye shutter
61 image data conversion circuit
62 oblique line interpolation circuit
70 oblique line detecting part
71, 75 1Hdelay
72 subtractor
73 comparator
74, 81 2CKdelay
76 4CKdelay
77, 78 AND gate
80 interpolated data generating part
82 OR gate

1. A plasma display apparatus driving method,
the plasma display apparatus including:
a plasma display panel having a plurality of discharge cells arranged therein, each of the discharge cells having a scan electrode, a sustain electrode, and a data electrode; and
a driver circuit for driving the plasma display panel, the driving method comprising:
forming one field period formed by a subfield that displays an interlace signal as an image signal thinned out every one line and a subfield that displays oblique line interpolated data generated by interpolating an oblique line detected by an image signal,
in the subfield displaying the image signal, performing two-line simultaneous address operation where a scan pulse is applied simultaneously to two adjacent scan electrodes so as to generate an address discharge in the discharge cells.

2. The plasma display apparatus driving method of claim 1, wherein the image signal is a stereoscopic-view image signal in which an image signal for a right eye and an image signal for a left eye are alternately repeated in each field.

3. A plasma display apparatus comprising:
a plasma display panel having a plurality of discharge cells arranged therein, each of the discharge cells having a scan electrode, a sustain electrode, and a data electrode; and
a driver circuit for driving the plasma display panel,
wherein one field period is formed by a subfield that displays an interlace signal as an image signal thinned out every one line and a subfield that displays oblique line interpolated data generated by interpolating an oblique line detected by an image signal,
in the subfield displaying the image signal, the driver circuit performs two-line simultaneous address operation where a scan pulse is applied simultaneously to two adjacent scan electrodes so as to generate an address discharge in the discharge cells.

4. The plasma display apparatus of claim 3, wherein the image signal is a stereoscopic-view image signal in which an image signal for a right eye and an image signal for a left eye are alternately repeated in each field, and the driver circuit has a timing signal output part for outputting a timing signal in synchronization with a right-eye field that displays the image signal for the right eye and a left-eye field that displays the image signal for the left eye.

5. A plasma display system comprising:
a plasma display panel having a plurality of discharge cells arranged therein, each of the discharge cells having a scan electrode, a sustain electrode, and a data electrode;
a driver circuit for driving the plasma display panel,
wherein one field period is formed by a subfield that displays an image signal and a subfield that displays oblique line interpolated data generated by interpolating an oblique line detected by an image signal, and the driver circuit receives a stereoscopic-view image signal in which an image signal for a right eye and an image signal for a left eye, each of the image signals is an interlace signal thinned out every one line, are alternately repeated by field,
the driver circuit further including:
a timing signal output part for outputting a timing signal in synchronization with a right-eye field that displays the image signal for the right eye and a left-eye field that displays the image signal for the left eye; and
a pair of shutter glasses for opening and closing a right eye shutter and a left eye shutter based on a timing signal output from the timing signal output part.
